(19) United States
(12) Patent Application Publication
(10) Pub. No.: US 2002/0178353 A1
(43) Pub. Date: Nov. 28, 2002

(54) Secure messaging using self-decrypting documents

(76) Inventor: Randall James Graham, Huntington Beach, CA (US)

Correspondence Address: KNOBBE MARTENS OLSON & BEAR LLP, 2040 MAIN STREET, FOURTEENTH FLOOR, IRVINE, CA, 91614, US

(21) Appl. No.: 09/833,027

(22) Filed: Apr. 11, 2001

(51) Int. Cl. H04L 9/00

(52) U.S. Cl. 713/151; 713/200

(57) ABSTRACT

The described system and methods provide a secure document delivery system that allows for high-security, high-volume e-mail delivery of documents. The security is provided through encryption and decryption of messages and documents through a browser based software application. The system also provides for tracking the progress of the delivery of each document in a tracking database. It provides a seamless interface to the recipient using existing e-mail client programs and browsers with no additional requirements for installation of special software. Optionally, the system can provide round trip capability for applications that need it.

### BACKGROUND OF THE INVENTION

### Appendices

This specification includes a partial code listing of a preferred embodiment of the invention, attached as Appendices A & B. These materials form a part of the disclosure of the specification. The copyright owner has no objection to the facsimile reproduction of this code listing as part of this patent document, but reserves all other copyrights whatsoever.

### FIELD OF THE INVENTION

This invention relates to the transfer of encrypted electronic messages or documents between users. More specifically, this invention relates to permitting a message or document recipient to receive and decode encrypted data on substantially any computer platform using existing programs and software.

### DESCRIPTION OF THE RELATED ART

Businesses have long depended on paper document delivery using postal mail for sending important documents to their customers. Monthly bills, confirmations of trades of securities, various notifications required by law and other important documents are now delivered via postal mail because it is reasonably secure and has worked in the past. As web-based systems have been introduced their implementation has not gained wide acceptance by institutions and service providers desiring secure and reliable delivery, and they have generally been used for less important documents and notifications. Due to the expense and relative slowness of delivering paper documents via postal mail, secure electronic delivery of the documents would provide a substantial cost savings to businesses and improved delivery speed for their customers if a solution were available that would garner wide customer acceptance.

Using electronic transmissions such as e-mail as opposed to a web-based solution allows companies to initiate delivery of a document, relieving the dependence upon the recipient to periodically check a website. This e-mail model can be compared more closely with the current postal mail model than other web-based solutions. Current e-mail solutions are inconsistent in recording electronic transmissions due to e-mail clients either not creating a return receipt or by suppressing the return receipt request upon sending. Each e-mail client installed on some user's computer has varying settings that are chosen upon installation. These variations make it difficult to reliably record the transmission of every message sent and opened by a recipient. It is a desirable attribute for a system to have the capability of recording and effectively logging electronic transmissions from all types of clients.

Additionally, with privacy concerns coming to the forefront, it is increasingly important that information transmitted across a network or via the Internet be encrypted so that it cannot be viewed, except by the intended recipient. Data, as it travels electronically, is both visible and accessible to anyone with software that allows viewing of packets. For this reason it is generally desirable to encrypt data files or blocks before they are sent, and then to decrypt the data files or blocks, hereafter referred to as e-mail messages or documents, on whatever computer they are eventually transmitted to. By encrypting the data, it becomes meaningless to anyone who might intercept the information on its way to the recipient.

However, working with encryption software is not always simple. To operate effectively, the recipient must have access to a computer that has appropriate decryption software available. Locating and configuring such software may be time consuming and complicated. Furthermore, each different type of encryption system may require its own specialized decryption code. Additionally, certain types of software may not be available for every type of computer platform that the recipients of such mail may wish to use.

Therefore, there is a continued need for techniques for delivery of secure electronic messages which may be decrypted by the intended recipient without the need for specialized software to be installed on the recipient's computer.

### SUMMARY OF THE INVENTION

The current invention solves the above problems, allowing substantially any computer that runs a standard Internet content viewing software package (e.g., a web browser that accommodates active content), regardless of the operating system, to decrypt messages or documents without the need for any additional software installation on the computer by the user. Since the messages and documents are decrypted in a web-based application, the current invention standardizes the way in which the sender receives a receipt of transmission, allowing for enhanced data tracking. This invention also allows the cryptography to occur across substantially any platform or operating system and even allow for secure, encrypted return messages or documents. It does not require any additional software or hardware to be installed on a recipient computer beyond the software necessary to connect to the Internet and to view active content.

One aspect of the invention is a secure electronic document that is contained within a document wrapper, preferably a document compatible with Hyper Text Markup Language (hereafter HTML), encrypted data representing a source message which has been encrypted with an encryption key, processing instructions located within the document wrapper, and a decryption element configured to decrypt the encrypted data within the document wrapper.

In an additional mode of the present invention, the document wrapper may be formatted in HTML or XML formats. In further additional modes of the present invention, the document wrapper is configured to present an interface to a recipient when viewed in a browser, the interface allowing the recipient to enter a password for the encrypted message and then initiate the decryption of the message.

In an additional mode, the processing instructions may be executed in response to the initiation of the decryption of the message by the recipient. The processing instructions are configured to send the password to the decryption element. In another additional mode, the processing instructions comprise script code embedded within the document wrapper.

In another additional mode, the processing instructions may contain ActiveX controls, JavaScript commands, Visual Basic commands, a Java applet, or any other variation or combination of these.

Another aspect provides a secure messaging system for protecting the contents of an electronic message being sent to a recipient. The system has an encryption module for preparing a secure document in an HTML-compliant format. The system also includes a means to receive a password that is later hashed into a decryption key for the electronic message. An electronic mail gateway module may be configured to forward the secure document from the encrypting module to a recipient. The encryption module is configured to create a secure document by encrypting the message with the key and then embedding it in the secure document. The secure document has an HTML wrapper, the encrypted message, a processing script, and a decryption element. The processing script contains instructions for accessing the encrypted message, and the decryption element is capable of recovering the electronic message from the encrypted message when presented with a password by the recipient.

In an additional mode, the decryption element is downloaded across a communications medium when it is needed. This decryption element may comprise a Java applet or an Active X control.

In another additional mode, the decryption element is configured to send a confirmation message to the encrypting module confirming the successful access of the encrypted message by the recipient. This message may include information identifying the recipient of the message in a further additional mode.

In another aspect of the invention, a method is provided for sending a message to a recipient. The method has the steps of receiving a source message, preparing an encrypted message by scrambling the message using the encryption key and an encryption algorithm, forwarding the secure document to a mail gateway module, and sending the secure document to a recipient. The preparation of a secure document includes creating an HTML-compliant wrapper, and then embedding the encrypted message, a processing script, and a decryption element in the wrapper. The processing script contains instructions for accessing the encrypted message. The decryption element includes a module capable of recovering the source message from the encrypted message when presented with a password by the recipient.

In an additional mode, the source message may be received as part of an XML template from a database or other source. The password may also be received from a database as part of an XML template in a further additional mode. The password is hashed to produce the encryption key in yet another additional mode.

In yet another aspect of the present invention, a method is provided for sending and receiving a message. The method has the steps of receiving a source message, preparing an encrypted message by scrambling the message using the encryption key/encryption algorithm, and preparing a secure document. The secure document contains an HTML-compliant wrapper, the encrypted message, a processing script, and a decryption element. The secure document is forwarded to an e-mail gateway module that sends it to a recipient. The recipient processes the wrapper of the secure document using a browser, producing an interface into which a password may be entered. The browser then executes the processing script of the secure document, and the source message is recovered by using the decryption element on the encrypted message with the password. The recovered source message is then presented to the recipient.

### BRIEF DESCRIPTION OF THE DRAWINGS

These and other features will now be described in detail with reference to the drawings of preferred embodiments of the invention, which are intended to illustrate, and not to limit, the scope of the invention.

FIG. 1 illustrates a high-level system overview for the flow of data, through an encryption process, to a device where it is decrypted and able to be viewed by a recipient.

FIG. 2 is a diagram that shows the flow of information through the various components of a system for preparing and sending an encrypted, secure message to a recipient as in FIG. 1.

FIG. 3 is an illustration showing components contained within a secured, encrypted document used to transport a message that is sent to a recipient as in FIG. 2.

FIG. 4 is an illustration showing a process flow for preparing a secured, encrypted document as in FIG. 3.

FIG. 5 is a flow diagram showing the process for authenticating a user and decrypting the message in the secure document of FIG. 3 for access by a recipient.

### DETAILED DESCRIPTION OF THE PREFERRED EMBODIMENT

The following detailed description is directed to certain specific embodiments of the invention. However, the invention can be embodied in a multitude of different ways as defined and covered by the claims. In this description, reference is made to the drawings wherein like parts are designated with like numerals throughout.

This application includes words and references that are commonly understood to those of skill in the computer arts. For clarity and precision, certain terms are specifically defined below and used consistently with these definitions herein.

The term “communications medium” refers to any system that is used to carry information between devices such as phones or computers. Communications media may include the Internet, which is a global network of computers. The structure of the Internet, which is well known to those of ordinary skill in the art, includes a network backbone with networks branching from the backbone. These branches, in turn, have networks branching from them, and so on. Routers move information packets between network levels, and then from network to network, until the packet reaches the neighborhood of its destination. From the destination, the destination network's host directs the information packet to the appropriate terminal, or node. For a more detailed description of the structure and operation of the Internet, please refer to “The Internet Complete Reference,” by Harley Hahn and Rick Stout, published by McGraw-Hill, 1994.

One of ordinary skill in the art, however, will recognize that a wide range of communication media may be employed in the present invention other than the Internet. For example, the communication medium may include interactive television networks, telephone networks, wireless data transmission systems such as cellular networks or infrared networks, two-way cable systems, customized computer networks, and the like.

One popular part of the Internet is the World Wide Web. The World Wide Web contains different computers that store documents, which may contain graphical or textual information. These documents are made available to users across the Internet. The computers that provide these documents on the World Wide Web are typically called “websites.” A website is defined by an Internet address that has an associated electronic page. The electronic page can be identified by a Uniform Resource Locator (URL). Generally, an electronic page is a document that organizes the presentation of text, graphical images, audio, video, and so forth.

Hypertext Markup Language (HTML) is a page description language generally used for formatting documents, particularly documents which will be made available on a website. Standard HTML format documents contain HTML code and may also contain client side scripts, which are discussed below. HTML defines the structure and layout of a Web document by using a variety of tags and attributes.

Certain extensions to the basic HTML format are used which include certain additional features beyond page description. One of these extensions is referred to as Dynamic HTML (DHTML). Dynamic HTML refers to new HTML extensions that will enable a Web page to react similarly to user input as a standard HTML page with the exception that it can react without sending requests to the Web server.

The Extensible Markup Language (XML) allows specific markups to be created for specific data. XML may be viewed as a superset of HTML in that data described in HTML format will generally be appropriately interpreted by XML enabled software. In this sense, programs capable of interpreting XML, DHTML, or XHTML are able to properly interpret HTML formatted documents. Such programs can be considered “HTML-compliant.”

The term “browser” refers to a software program that allows a consumer to access different content that is provided through the communication medium. More generally, a browser is any program that displays data described in a particular data format, such as HTML, XML, etc. In one embodiment, the user's browser is the Netscape® Navigator developed by Netscape, Inc. or the Microsoft® Internet Explorer developed by Microsoft Corporation. One of ordinary skill in the art, however, will recognize that numerous other types of access software could also be used to implement an embodiment of the present invention. These other types of access software could include, for example, other types of HTML web browsers as well as other programs which are configured to display HTML formatted data, such as the Microsoft Outlook e-mail application.

“Java” refers broadly to a general purpose programming language with a number of features that make the language well suited for use on the World Wide Web. These features include a high degree of portability of code between platforms, as well as security features that protect a user's device from malicious programs. Small Java applications are called Java applets and can be downloaded from a Web server and run on your computer by a Java-compatible Web browser.

“Applet” refers broadly to a program designed to be executed from within another application. A Java-enabled web browser may download an applet in response to code placed within an HTML document, and then execute that applet locally. Because applets are small in size, cross-platform compatible, and highly secure, they are ideal for Internet applications accessible from a browser.

An additional type of Java program is referred to as a “servlef”. A servlet is a Java program that runs on a server. The term usually refers to a Java program that runs within a Web server environment. This is analogous to a Java applet that runs within a Web browser environment, except that it runs on a web server, rather than a web browser.

Encryption refers to the transformation of data into a secret code. In order to recover the original data, the data is decrypted, returning it to its original form. Generally, encryption involves scrambling the original data by using a technique in conjunction with a particular key. Many people may use the same technique, but as long as they do not share the same key, their data is secure from anyone without their key. To successfully decrypt a file requires knowledge of both the technique used to encrypt the information, and the key used with the technique. Encryption may be used with any data, without regard to whether it represents a text message, a computer program, a picture, or any other form of binary data. Herein, data that is going to be encrypted is referred to as “plain text” or “source data” when it is in its ordinary form (either before it is encrypted or after it is decrypted). Data that has been encrypted is referred to as “cipher text” or “encrypted data”.

Because knowledge of a particular key is generally required as part of the decryption process, the key can be used to authenticate the user to the system prior to decryption. If the user is unable to provide a key, or provides the wrong key, the original plain text may not be able to be recovered from the encrypted cipher text. However, cryptographic keys are generally difficult to memorize. In order to eliminate the need for memorization of keys, it is common to provide a system in which a user selects a password or passphrase (hereinafter, simply “password”), and a key is generated based upon that password. Various such techniques are known to those of skill in the art, and allow for a user to merely memorize a password, rather than a key itself.

One technique that may be used for such password authentication is for the password to be subjected to a one-way hashing function to produce a value which may be used as a key, or as part of a larger algorithm for generating a key. Various such hash algorithms are known in the art and are suitable for use in the present invention. These include without limitation, Message Digest 5 (MD5) and the Secure Hashing Algorithm (SHA). By applying the same hash algorithm to the password entered by the user, the appropriate key can be derived.

A “script” as used herein generally refers to a set of commands embedded within a data document, such as an HTML formatted document. The script specifies actions to be performed by the browser during the processing and display of the information within the document. Script formats that may be executed by common web browser programs include without limitation, JavaScript, VBScript, Jscript, and ECMA Script. Scripting commands may be used to handle data entered into forms displayed by HTML documents, as well as to process information directly. For example, as will be discussed below, the decryption element of the present invention may comprise script code embedded within an HTML document.

An Active X control is a program that can be executed from within another application. An ActiveX control can often be automatically downloaded and executed by a Web browser.

The below described system is an e-mail based solution that permits message recipients to receive and decode encrypted documents on any computer platform (Mac, Windows, Linux, etc.) using existing e-mail programs and browsers without the installation of special software.

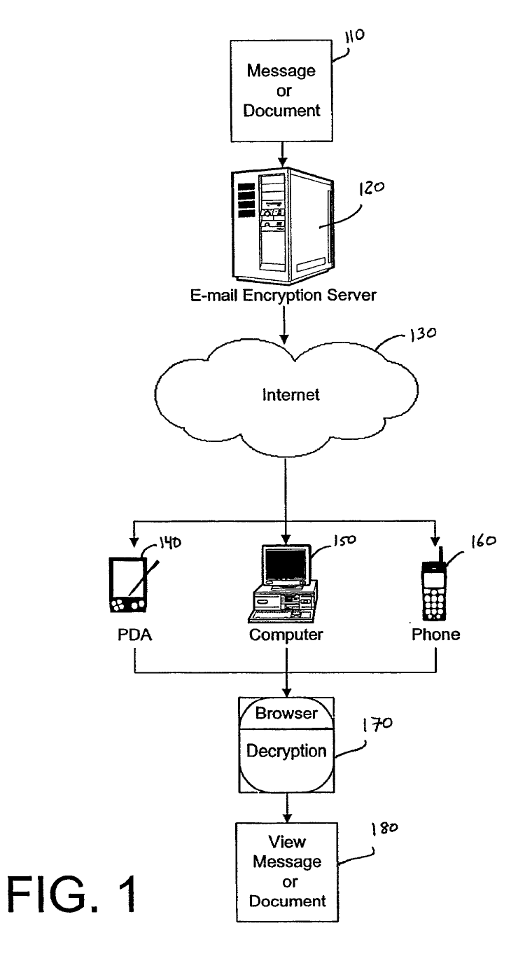

FIG. 1 is a high level overview of the entire system and the electronic transmissions therein. First, a message or file 110 is generated by an automated process in the course of operation of a business, or may be created by a user. In one embodiment the document may be created with a widely used text editing software application such as Microsoft's Notepad. In other embodiments the message or text could be created in a proprietary format or with the use of ASCII characters. Note that it is not even necessary that the message or file represent a document. Such messages 110 may represent text messages, executable programs, images in a variety of formats, or any other data which may be represented in a binary form. Any such file is referred to hereafter as a “message 110”.

The message 110 is then passed to a server 120 where it is encrypted and prepared for secure transmission. The process of encryption may include compression of the message 110 in order to reduce the amount of data that must be sent. The encrypted data represents the cipher text corresponding to the plain text of the original message 110. This is the same message 110, merely encrypted. In one embodiment the server 120 can be an e-mail encryption server 120 that accomplishes the task of recording transmissions in a database, encrypting documents, and sending the encrypted messages to a user in a secure electronic envelope. This envelope preferably comprises a file in HTML format that includes the encrypted document 110 as data and a link to a Java applet that decrypts the file.

In a more specific embodiment, one or more e-mail encryption servers 120 may be pre-configured into a rack or vertical mount case. Within the case preferably resides a processor, memory, a power supply, peripheral devices configured as an interface, and an Ethernet connection card to connect the server 120, through an IP address, to the Internet 130. The computer may be configured to run on a Microsoft Windows NT platform, a UNIX based platform, or any other suitable platform, and may use suitable database software for tracking purposes.

The e-mail encryption server 120 may be configured to run behind a firewall on an internal network or, alternatively, to allow data to flow to the Internet 130 without restriction. The server 120 is configured with both hardware and software to allow for communication with computers on a client's network. These computers may include a Simple Mail Transfer Protocol (hereafter SMTP) outgoing mail server, a Post Office Protocol (hereafter “POP3”) incoming mail server, a server providing XML data templates, and a customer's web server if the customer uses their own computers to process delivery confirmation notices. Hereafter, a “client” is intended to describe a company or an organization utilizing the above described system and a “recipient” is the company or individual user that receives communications from the client companies or organizations using the described system.

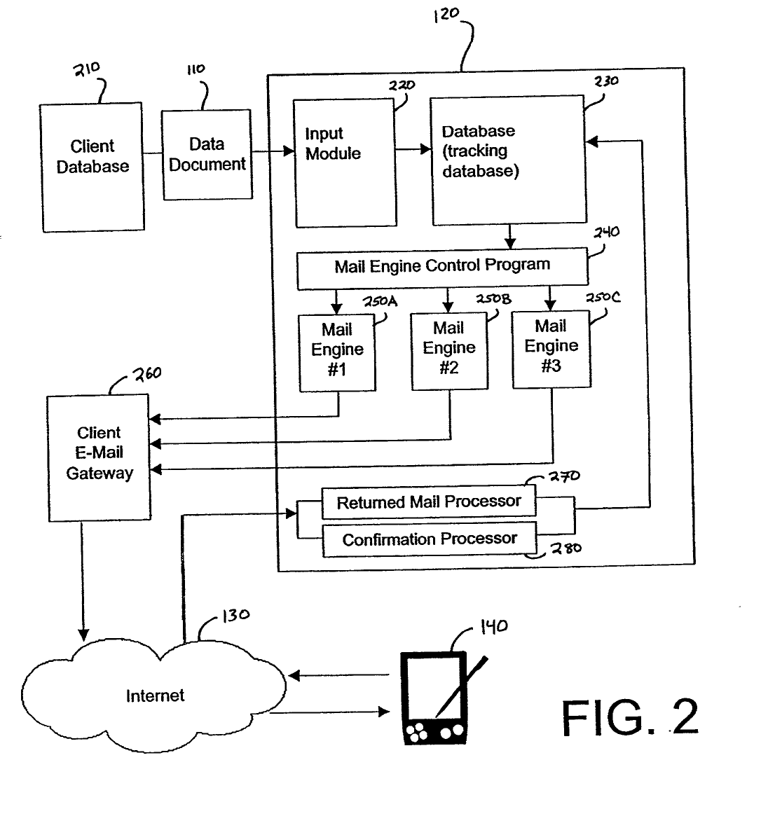

The server 120 generally includes an email encryption server, but other support servers such as those listed above, may provide necessary services to allow the system to operate more effectively. As used throughout, the term “e-mail encryption server 120” will be used to refer to any number of servers which perform the function described for the encryption server and the support servers herein. Examples of the above identified support servers are described below, and may also form a part of the system in further preferred embodiments, as shown in FIG. 2.

In one embodiment a client may have an SMTP gateway module behind its firewall that is responsible for sending e-mail out onto the Internet 130. The preferred embodiment is to have an e-mail encryption server 120 configured to interface directly with the SMTP server. If the client does not have an SMTP server on-site, the e-mail encryption server 120 can be configured to interface directly with the SMTP server of a specified Internet Service Provider (hereafter referred to as ISP). Those of skill in the art will recognize that the gateway module may also comprise appropriate software running as a process within a computer that also performs other functions, and need not comprise an independent server or other separate physical hardware. Any module, hardware or software, which forwards e-mail to the Internet will be referred to herein as a “gateway” or “gateway module.”

In another embodiment, the client may have a POP3 e-mail account to collect e-mails returned as undeliverable. Normally the client will set up a POP3 e-mail account in their e-mail system for this use. This e-mail address will be the one that appears in the “From:” field of the e-mail. Another e-mail address is usually used for the “Reply To:” field, which connects the recipient with customer service. The e-mail encryption server 120 is preferably able to connect to the POP3 server and download the undeliverable returned e-mail from it. Alternatively, the server 120 may contain software that acts as a POP3 client.

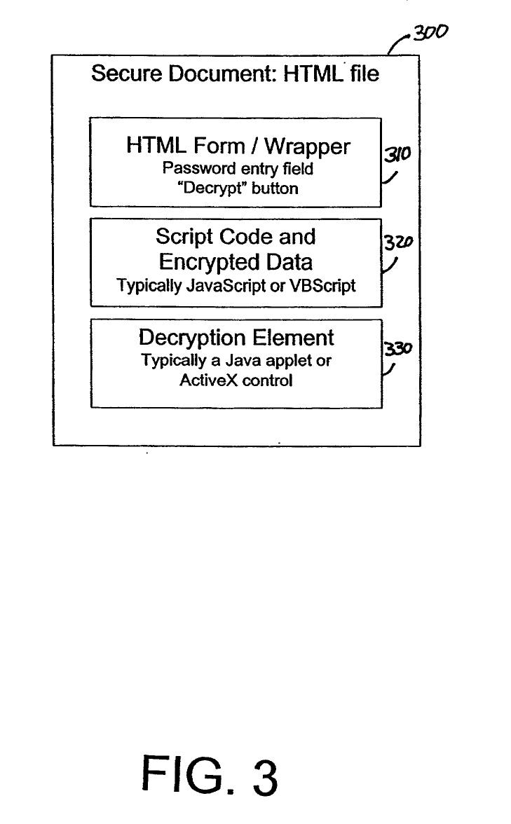

In another preferred embodiment, the client may use a confirmation processor to track delivery of secured messages. The confirmation processor 280 can be run on the e-mail encryption server 120 or on a client's web server. The confirmation processor 280 may be a Java servlet. The servlet may be hosted on a web server and have a URL (web address) associated with it. This URL is imbedded in each secured message 300 (see FIG. 3) sent to a recipient, and is accessed when the recipient opens the document 300. When the URL is accessed, the servlet updates the e-mail encryption server 120. If the servlet is hosted on one of the client's web servers, the servlet is preferably able to connect to the server 120. If the servlet is hosted on the e-mail server 120, then access privileges are desirably configured to allow access to the URL of the confirmation processor 280 from outside the customer firewall.

In an additional embodiment, the applet used for decryption is retrieved from the Internet 130 by the recipient's device 140, 150, 160. The applet may be retrieved from the encryption server 120, or it may be retrieved from a server belonging to the client. Additionally, the applet may be stored on an additional server associated with the operator of the encryption server 120, but not on the encryption server 120 itself. Preferably, such an applet source server is accessible by any recipient of an encrypted message over the Internet 130 regardless of who maintains or operates such a server.

In yet another embodiment, a client server is provided that sends XML data templates to the e-mail encryption server 120. This XML data source is desirably configured to allow electronic transfer of files to and from any of the various servers and processes described above. In a further embodiment, the data could be transferred to the e-mail encryption server 120 via an application programming interface (hereafter referred to as API).

As described above, the Internet 130 may provide connectivity between any users who can connect to and maintain a network connection to any part of the Internet. In one embodiment, the Internet 130 is the primary means to transfer a message 110 from the e-mail encryption server 120 to a device 140, 150, 160 of the recipient. This electronic transfer may include a wireless connection to the Internet 130 that connects via a radio frequency network, cellular network, pager network, or other wireless connection. However, those skilled in the art will recognize that the electronic data transfer may occur between cellular devices without the connection to a land based Internet 130 if the encryption server 120 is so configured.

When an electronic message 110 is sent to a recipient across the Internet 130, it may be received, decrypted, and read by various electronic devices. The devices described below include, without limitation, devices in the current state of the art capable of electronic transactions suitable for receiving and decrypting an encrypted message. Bearing in mind future technologies, the message 110 may also be downloaded, decrypted, and viewed by any future device containing a means for connecting to the Internet 130 and having the capabilities of viewing active content web pages through a browser application.

In one embodiment, a Personal Digital Assistant 140 (hereafter referred to as PDA) may be used as a primary receiving device. For example, but without limitation, a Palm Pilot running the Palm Operating System and including a modem to connect wirelessly to the Internet 130 may be configured to receive an encrypted message 110 and view the decrypted message through Neomar's version of a Wireless Application Protocol (hereafter WAP) browser.

In another embodiment the encrypted message 110 may travel from the e-mail encryption server 120 through the Internet 130 and into a desktop computer 150. For the communication to occur the desktop computer 150 must have a means for establishing and sustaining a network connection to the Internet 130 or another communications medium. Such a connection may be made using devices such as an Ethernet card or a device that allows for the operation of a wireless Local Area Network (hereinafter LAN). Those of skill in the art will recognize that various means of connecting the various components of the described systems to the Internet 130 and to each other may be used without altering the nature of the invention or exceeding the scope of what is disclosed herein. When the encrypted message 110 enters the desktop computer 150 it can be decrypted and viewed by a web browser, such as Microsoft's Internet Explorer or Netscape's Navigator browsing software as will be described below.

Another embodiment of a device that can receive encrypted messages 110 may comprise a cellular phone 160 or a hybrid cellular phone/PDA. The phone 160 may connect into the land based Internet 130, or directly into a corporate network via a cellular connection to a cellular reception site which is connected to the appropriate land-based network. The encrypted message 110 may be received, decrypted, and viewed all on the same device through an appropriate browser application. Hereafter, “device 140” will refer to any device 140, 150, 160 as described above.

As briefly stated above, each device 140 has the ability to connect to the Internet 130 to receive an encrypted message 110 from an e-mail encryption server 120. The recipient can then open the message in a browser 170 where the browser attempts to verify the authenticity of the message. The browser performs a decryption process that allows the recipient to extract the original message or to save it to a local memory destination.

FIG. 2 is a diagram that shows the flow of an encrypted message 110 through various software modules through which it is distributed to a recipient in one embodiment of the system. A client database 210 belonging to a company or an organization that uses the described system to communicate with its customers maintains information related to the recipients of e-mail to be sent by the system. Although disclosed in the context of a client whose customers receive notices such as bills or invoices, the word “recipients” shall be used herein to describe any recipient of an encrypted message sent using the described secure message system.

The client database 210 may contain such information as recipient name, e-mail address, profile, etc., as well as a list of whatever correspondence the recipient is enrolled to receive. For example, the client database 210 may be for Citibank Credit Corporation and the information contained within the database 210 may be each customer's profile and account information. The system can be configured to automatically send a secure, encrypted copy of the customer's monthly statement and minimum payment information to each enrolled customer. The described system may also monitor and record the electronic transmission of the message 110 and record every success and failure of the delivery of a message into a tracking database 230, as described below.

The client database 210 is used to provide information for the messages to be sent. For example, if messages are to go to all of the customers that have last names starting with the letter “A”, this data will come from a particular field in the client database 210. An XML data template is created and the recipient's information is transferred directly into the template from the client database 210. The client database 210 provides the appropriate data about each message to be delivered, such as the e-mail address, to the e-mail encryption server 120 in standard XML format. Such templates are defined based upon their Data Type Definitions (DTD's). A DTD appropriate for use in a system such as is described herein is included in Appendix A. Inside the e-mail encryption server 120, the input module 220 stores the information in a record in the tracking database 230. Optionally, the message 110 may be compressed before storage.

The mail engine control program 240 monitors the tracking database 230 for records that need to be sent. When a record is found that needs to be sent it is forwarded to one of the mail engines 250 for processing. FIG. 2 shows three mail engines 250A, 250B, 250C running, but a variable number can be run in order to meet the customer's performance goals. For the remainder of this application the mail engine will be referred to as “mail engine 250.” The mail engine 250 encrypts the message 110 and imbeds it in the HTML secure wrapper 310 along with appropriate scripting code 320 and a decryption element 330 to form the secure document 300 as is described in more detail below. The mail engine 250 then forwards the e-mail with the secure document 300 as an attachment via a standard SMTP e-mail gateway module 260 belonging to the client. The e-mail gateway 260 transfers the secure document 300 in the same way it would transfer any other e-mail attachment. The secure document 300 is then forwarded via the Internet 130 or another communications medium to the recipient's device 140, such as the PDA shown in FIG. 2.

Also shown in FIG. 2 is a returned mail processor 270. This is a process that may be run on the e-mail encryption server 120 which monitors the e-mail gateway module 260 for messages returned as undeliverable. When a message is returned as undeliverable, this process updates the status of the message in the tracking database 230. Optionally it can mark the database record for further action such as being retransmitted or sent to a secondary delivery address.

Additionally, a confirmation processor 280 may be used, as shown in FIG. 2. This process listens for notifications that a recipient device 140 has opened the secure document 300. This occurs when a recipient successfully decrypts and views the message 110. The confirmation processor 280 then updates the status of the message in the tracking database 230.

FIG. 3 is an illustration showing the structure within a secure document 300. The secure document 300 is comprised of three primary components that carry the data, authenticate the recipient, and decrypt the data when presented with a proper authentication. These components are, respectively, the HTML wrapper 310, the script code 320 (which also includes the encrypted message 110), and the decryption element 330.

The HTML form 310 that the message 110 arrives in, also referred to herein as the “wrapper” of the message, carries with it the user interface for the decryption process. At a minimum the interface contains a single text entry field for password entry and a decryption button to request decryption of the included message 110. This section may be written in standard HTML or another universal language recognized by standard browsers. These could include without limitations, extensions of the HTML standard, such as DHTML, Extensible HTML (XHTML), as well as such other languages known to those of skill in the art. This wrapper 310 includes information describing the layout and formatting of the interface presented to a recipient when the secure document 300 is opened in a browser. The interface generated by the wrapper 310 may also include additional buttons, as well as instructions or other information that may be helpful to the user (such as the usemame of the individual whose password was used in encrypting the message 110).

The second component is a set of processing instructions that contain the script code 320 that is invoked when the decryption button is pressed. Also included within the script code 320 is the encrypted message 110. This encrypted data may be stored as a literal string within the script code 320 in a preferred embodiment. The script code 320 passes the encrypted message 110 and the password that was entered into the interface presented by the wrapper 310 to the decryption element 330. This component is written in a scripting language such as JavaScript, JScript, ECMA Script, Visual Basic Script, or the like. It is preferable that the scripting language used is one that is recognized and properly interpreted by as many different browsers as possible.

The decryption element 330 performs the actual decryption of the encrypted message 110. The decryption element 330 may be written in a scripting language such as JavaScript, and included in its entirety in the secure document 300. It may also be an active component such as a Java applet or ActiveX control that may be included by reference and downloaded on demand from a publicly available server via the Internet 130, such as the applet source described above. The decryption element 330 performs the appropriate decryption based upon the password entered by the recipient and the encrypted message 110. The password is hashed as described above to produce the decryption key, and then this key is used to decrypt the message 110. The output of this decryption process is the original message 110 or file that was sent by the client in plain text form.

In one embodiment, the algorithm that is used to encrypt the message 110 is the Blowfish algorithm developed by Bruce Schneier. It is a symmetric key algorithm that implements a 64-bit block cipher. Blowfish itself supports a variety of key lengths, but the described system uses a key length between 32 and 448 bits.

The Blowfish algorithm is known in the art. The Blowfish algorithm is a Feistel network consisting of 16 rounds. The Blowfish algorithm is used in Cipher Block Chaining (CBC) mode with an initialization vector (IV). This approach ensures that even if an identical message is sent repeatedly to the recipient, it will have a different ciphertext each time it is encrypted. This protects against a variety of cryptanalytic attacks against the encrypted document.

Those of skill in the art will recognize that other algorithms and key lengths may be used to secure the encrypted message 110. For example, in an alternate embodiment the Advanced Encryption Standard (hereafter referred to as AES) may be used. The proposed algorithms for AES are designed to use only simple whole-byte operations and to be more flexible than previous encryption standards, in that both the key size and the block size may be chosen to be any of 128, 192, or 256 bits. The algorithm that is proposed for AES is called Rijndael and was created by Dr. Joan Daemen and Dr. Vincent Rijmen, both cryptographers from Belgium.

AES could be implemented into the current invention with one of three different key sizes: 128, 192 or 256 bits, where 256 bits offers the most security. The AES algorithm may be applied to a message 110 in a process that uses thirteen rounds to encrypt. A key may be generated based upon a hash of a password and the message 110 transmitted to a recipient in the same manner as is described above with respect to the Blowfish algorithm.

In some applications, such as electronic bill payment, data needs to be sent back to the sender of an encrypted message. This is referred to as “round-trip” capability because a secure message is sent to the recipient, and a secure response may be returned to the sender of the message. In order for this round-trip functionality to work in the greatest number of environments and to provide each recipient with a seamless experience, the present system supports using a secure HTTP (hereafter referred to as SHTTP) connection for sending data back to the sender. Since many companies already have a SHTTP server available for securing web-based transactions, this approach facilitates integrating the described system for sending secure e-mail with existing secure web-transaction systems. For clients who do not have an existing web-based solution this approach allows them to use off-the-shelf hardware and software to implement one.

The connection back to the SHTTP server need not use Blowfish or AES encryption techniques. SHTTP uses its own encryption system as part of the Secure Sockets Layer (hereafter referred to as SSL) standard for communication in web environments. This system normally provides encryption using a 40-bit key, but may also use 128-bit encryption.

Such round-trip confirmation processing may also be provided by having the decryption element itself send an appropriate message to a particular address upon successful decryption of the message 110.

In an alternate embodiment, confirmation of successful decryption may be made by embedding a link into the source message 110 prior to encryption which, when read by an appropriate browser, will attempt to load a particular tag file from a web server of the client. One of these tag files may be created for each secure document 300 sent. The contents of this file are not important, and such files may be made as small as possible for convenience. For example, such tag files may represent 1-pixel pictures with random names. By running a servlet which tracks file access on the web server which hosts these tag files, the server may be made aware of a particular file is requested. Because a particular file is only referenced by the source message 110 of a particular secure document 300, any access of a particular file indicates that the source message containing the link to that file has been successfully decrypted. Therefore, access to a particular file is used as an indication that the source message 110 containing that link was successfully decrypted and viewed by a recipient's device 140.

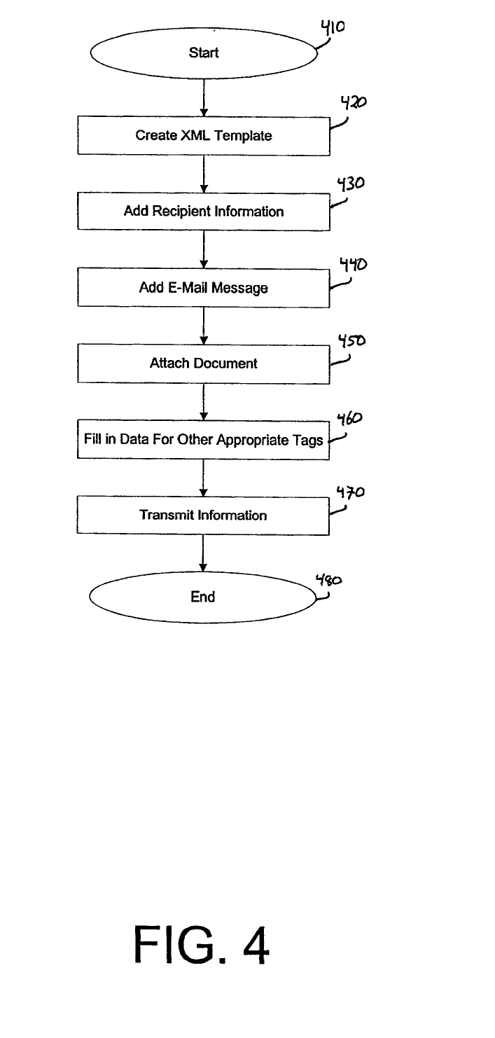

One process for creating a secure document 300 is shown in FIG. 4. The secure document 300 can be sent to a recipient either as an HTML attachment in an e-mail or just as an e-mail with a link back to a secure server where the secure document 300 is stored.

The process begins at a start state 410 where the client initiates a request from their database 210 to send a secure message. Moving to state 420, an XML template is created in a format that includes the fields that the particular client requires. These fields may vary from client to client. Progressing to state 430 the recipient's information is either imported from a client database 210 or a user enters the information by hand into the XML template. Once the template is populated, in state 440 an e-mail message representing a cover sheet is added to the appropriate field of the XML template.

Continuing to state 450, the source message 110 or a pointer to the source message 110 is placed into the appropriate portion of the XML template. The source message 110 may have one of various file extensions as long as a standard browser or other application can recognize the intended information. Continuing to state 460, other appropriate tags are filled in with any additional information which may belong in the XML template, e.g. whether or not to send a return acknowledgement to a confirmation processor 280, how to format the message (e.g., UU encoding, MIME encoding, etc.), what to do in case of failed delivery, etc.

At this time, the message 110 encrypted based upon the key corresponding to the intended recipient, and this encrypted message 110 is then imbedded into the secure document 300 as described above. The e-mail preparation is then complete and the e-mail with the secure document 300 attached may be forwarded to the e-mail gateway module for transmission to the recipient in state 470, as is discussed above with reference to FIGS. 1 and 2. The process completes at an end state 480.

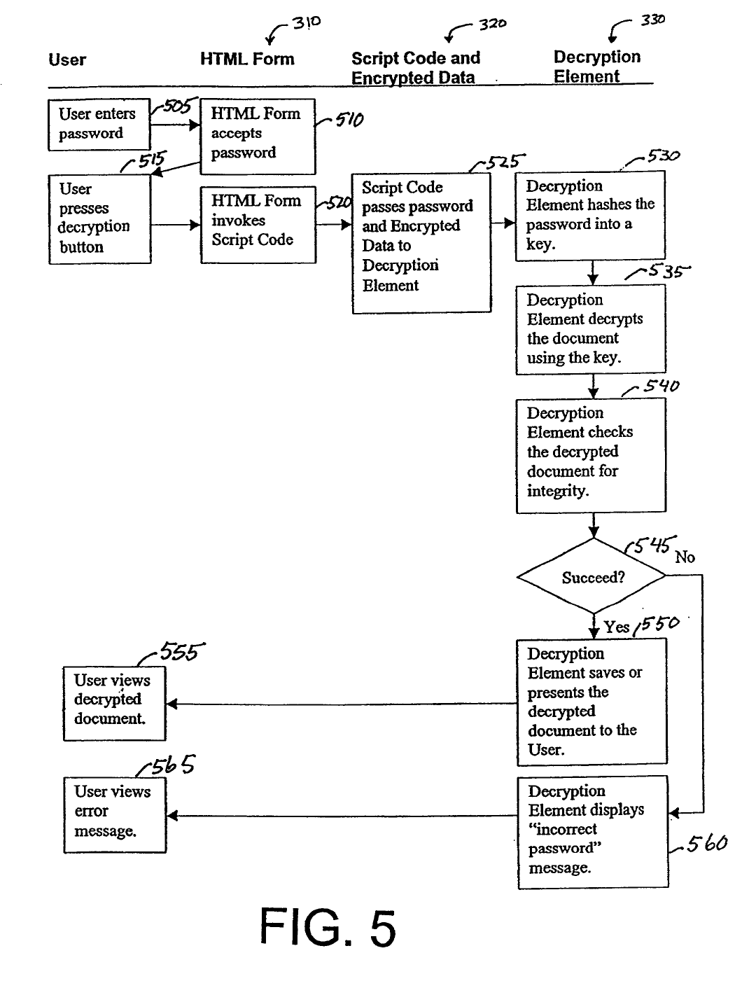

FIG. 5 illustrates one process for a recipient authenticating himself and initiating the decryption process of an encrypted message 110. When the recipient receives the e-mail message, the secure document 300 is attached to it. When the recipient opens the attachment in a web browser or other HTML viewer program, the interface defined by the HTML wrapper 310 appears. This preferably includes a prompt for the user to enter his password and a button to click in order to begin decryption. If the password is successfully entered then the message 110 is decrypted and displayed within the browser. This is all accomplished without the user installing any additional software.

By using a standard language, such as Java, which is interpreted in a machine-independent manner, the code for the decryption processes is not tied to any specific operating system or processor type. The recipient can use any device 140 that has an e-mail client program that supports attachments and has a web browser that supports the appropriate language.

In one embodiment, the secure document 300 that is attached to the e-mail has the encrypted message 110 imbedded in its script code 320. The secure document 300 also includes a link to a Java applet for use as the decryption element 330. When the recipient opens the attachment, the web browser or other HTML enabled program downloads the Java applet if it is not already present on the computer.

The HTML wrapper 310 includes a prompt that requests a password from the recipient. Once a password is entered and the button is pressed to begin decryption, the password is hashed into a value that is used to derive a decryption key for the encrypted message 110. This decryption key is used by the decryption element 330 to decrypt the encrypted message 110, and then the decryption element passes the decrypted message to the browser or HTML enabled e-mail program in its plain text form to be displayed.

In one preferred embodiment, the decryption element 330 is run within a Java virtual machine created by the Java interpreter upon the recipient's device 140. Because the code is only able to manipulate the Java virtual machine, this minimizes the potential for interference with the recipient's device 140 by either poorly written applets or malicious documents which contain links to applets designed to harm the recipient's device 140. In an alternate embodiment, the decryption element may be able to write the document to the recipient's device 140 directly, or otherwise save a copy of the message 110 after it is decrypted.

In one preferred embodiment, the Java applet includes a complete implementation of the AES algorithm using 256 bit keys. This Java applet is configured to execute on any Java enabled browser or email program, regardless of the operating system in use, processor type of the device, or individual configuration of the device. The Java virtual machine that is created when running a Java enabled browser executes this code in the same way, regardless of the underlying system.

Back at the site of the client system, a notification is received when the recipient opens the secure document 300 or if the delivery of the e-mail fails. The tracking database 230 is updated and a client-specified action takes place. If the e-mail delivery has failed, possible actions include: resending the message to the same address, trying to send the message to an alternate address, printing a report, sending notification to the system administrator, and such other responses as will be understood to those of skill in the art. The information within the tracking database 230 may be used to generate summary reports on a routine basis or upon request from an administrator in order to review the operation of the system as needed.

As shown in FIG. 5, the decryption process starts at state 505 where the recipient is prompted to enter a password to authenticate the message. State 510 shows that the HTML wrapper 310 accepts the password. Moving to state 515 the recipient presses a button located within the message to initiate the decryption process. In one embodiment, when the recipient presses the decryption button the password is hashed using a one-way hashing algorithm and the result of the hash is a 160 bit value that is used as the decryption key. In another embodiment there may be two buttons to initiate the decryption process. The first might be an “open” button that, when pressed, decrypts the message 110 and opens it in the current browser window. The second, might be a “save” button that, when pressed, saves the decrypted message 110 to a user defined location.

Continuing to state 520 the HTML wrapper 310 sends a positive response to the confirmation processor 280 and then invokes the script code 320. Continuing to state 525 the script code passes the password and the encrypted message 110 to the decryption element 330. In state 520 the decryption element 330 hashes the password into a key for use in decrypting the message 110. The decryption element 330 then decrypts the message 110 using the key that was derived by hashing the password, in state 535.

Moving forward to state 540 the decryption element 330 then verifies the integrity of the decrypted message 110 and ensures that it was decrypted properly. Decision state 545 asks if the decryption was a success. If the decryption was successful, the decryption element 330 saves or displays the decrypted message 110 in a browser in state 550. In state 555 the recipient views the message 110 in its decrypted, plain text form. If the decryption was not a success in decision state 545, then the process moves to state 560 where the decryption element 330 displays “incorrect password” to the recipient. In state 560 the recipient views the error message.

Although the XML code used to embody the system described herein may vary in both style and certain aspects of function, a preferred embodiment of XML code suitable for being imbedded into a secure HTML document wrapper 310 is shown in Appendix B.

Note that the secure document 300 and the associated decryption process on the recipient device 140 as described above need not be part of an e-mail message. In further embodiments of the present system, the secure document 300 may also represent a secure web page designed to only be viewable by those with access to the appropriate password. The host of the web page would prepare the web page that they wish authorized users to be able to view, and then encode this web page as the “message” 110 of the secure document 300.

This secure document 300 may then be made publicly accessible on an ordinary web server with an ordinary URL. When a browser on a device 140 accesses the URL for the web page, the secure document 300 is transferred to the recipient's device 140. The user may then enter the password to decrypt the message 110 in the same manner described above. The message 110 once decrypted will be the original web page the host wished to provide. By using this system, this web page may be made available only to those with a password, and no server side processing or securing of passwords is required once the secure document 300 is created.

The various embodiments of the client-less secure messaging system described above in accordance with the present invention thus provide a means to allow secure document delivery supporting high-security, high-volume e-mail delivery of documents. Furthermore, they can track the progress of the delivery of each document and store such tracking data into a tracking database 230. They also provides a seamless interface to the recipient using existing e-mail client programs and browsers with no additional installation of special software required. They may also provide round trip capability for applications that need it.

Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Furthermore, the skilled artisan will recognize the interchangeability of various features from different embodiments. For example, the use of AES encryption may be used in systems that also make use of round-trip messaging. In addition to the variations described herein, other known equivalents for each feature can be mixed and matched by one of ordinary skill in this art to construct secure message systems in accordance with principles of the present invention.

Although this invention has been disclosed in the context of certain preferred embodiments and examples, it therefore will be understood by those skilled in the art that the present invention extends beyond the specifically disclosed embodiments to other alternative embodiments and/or uses of the invention and obvious modifications and equivalents thereof. Thus, it is intended that the scope of the present invention herein disclosed should not be limited by the particular disclosed embodiments described above, but should be determined only by a fair reading of the claims that follow.

[image]

[image]

What is claimed is:

1. A secure electronic document, comprising:
a form for entry of a password by a recipient of the document, the form being adapted to be displayed within an HTML-compliant web browser;
an encrypted message; and
a decryption module that uses the password to decrypt the encrypted message for display within the HTML-compliant web browser;
wherein the document allows the encrypted message to be decrypted and viewed on a computer having an HTML-compliant browser installed thereon, without a need for decryption software installed on the computer.

2. The secure electronic document of claim 1 wherein the form is configured to present a password entry field and a decryption button to a user when the form is processed by the HTML-compliant web browser.

3. The secure electronic document of claim 1 wherein the encrypted message comprises an email attachment.

4. The secure electronic document of claim 1 wherein the decryption module comprises script code configured to be executed within the HTML-compliant browser.

5. The secure electronic document of claim 4 wherein the decryption module comprises JavaScript commands.

6. The secure electronic document of claim 4 wherein the decryption module comprises a set of Visual Basic script commands.

7. The secure electronic document of claim 1 wherein the decryption module is configured to receive a password and use the password to generate a decryption key, the decryption module being configured to use the decryption key to decrypt the encrypted message.

8. The secure electronic document of claim 1 wherein the decryption module comprises an Active X control.

9. The secure electronic document of claim 1 wherein the decryption module comprises software which is configured to be executed within a browser.

10. The secure electronic document of claim 1 wherein the decryption module is downloaded across a communications medium as needed.

11. The secure electronic document of claim 1 wherein the decryption module comprises a Java applet.

12. The secure electronic document of claim 1 where the decryption module comprises both a Java program and an Active X control.

13. A secure electronic document comprising:
a document wrapper including a description of a user interface;
encrypted data representing a source message which has been encrypted with an encryption key;
processing instructions located within the document wrapper; and
a decryption element configured to receive a password entered by a recipient via the user interface, and to use the password and the processing instructions to decrypt the encrypted data within the document.

14. The secure electronic document of claim 13 wherein the document wrapper is formatted in Hyper Text Markup Language.

15. The secure electronic document of claim 13 wherein the document wrapper is formatted in Extensible Markup Language.

16. The secure electronic document of claim 13 wherein the document wrapper is configured to present a password entry field and a decryption button to a user when the wrapper is processed by a browser.

17. The secure electronic document of claim 13 wherein the processing instructions are executed in response to a user clicking the decryption button.

18. The secure electronic document of claim 17 wherein the processing instructions are configured to send data from the password entry field to the decryption element.

19. The secure electronic document of claim 13 wherein the encrypted data comprises an email attachment.

20. The secure electronic document of claim 17 wherein the processing instructions comprise script code configured to be executed within a browser.

21. The secure electronic document of claim 20 wherein the processing instructions comprise JavaScript commands.

22. The secure electronic document of claim 20 wherein the processing instructions comprise a set of Visual Basic script commands.

23. The secure electronic document of claim 13 wherein the decryption element is configured to receive a password and use the password to generate a decryption key, the decryption element being configured to use the decryption key to decrypt the encrypted data and recover the source message.

24. The secure electronic document of claim 13 wherein the decryption element comprises at least one of either a set of Visual Basic script commands and a set of JavaScript commands.

25. The secure electronic document of claim 13 wherein the decryption element comprises an Active X control.

26. The secure electronic document of claim 13 wherein the decryption element comprises software which is configured to be executed within a browser.

27. The secure electronic document of claim 26 wherein the decryption element is downloaded across a communications medium as needed.

28. The secure electronic document of claim 26 wherein the decryption element comprises a Java applet.

29. The secure electronic document of claim 26 where the decryption element comprises both a Java program and an Active X control.

30. A secure messaging system for protecting the contents of an electronic message being sent to a recipient, the system comprising:
an encrypting module for preparing a secure document, the encrypting module configured to receive a key and an electronic message; and
an electronic mail gateway module configured to receive the secure document from the encrypting module and to send the secure document to a recipient,
wherein the encrypting module is configured to create an encrypted message by encrypting the electronic message with the key, and wherein the secure document comprises an HTML-compliant wrapper, the encrypted message, a processing script, and a decryption element, the processing script containing instructions for accessing the encrypted message, and the decryption element being capable of recovering the electronic message from the encrypted message when presented with a password by the recipient.

31. The secure messaging system of claim 30 wherein the decryption element is configured to send a confirmation message to the encrypting module confirming the successful access of the encrypted message by the recipient.

32. The secure messaging system of claim 31 wherein the confirmation message allows the sender to identify the recipient of the message.

33. A method for sending a message to a recipient, the method comprising the steps of:
preparing an encrypted message by encrypting a source message using an encryption key and an encryption algorithm;
preparing a secure document comprising an HTML-compliant wrapper, the encrypted message, a processing script, and a decryption element, wherein the processing script contains instructions for accessing the encrypted message, and wherein the decryption element includes a module capable of recovering the source message from the encrypted message when presented with a password by the recipient; and
sending the secure document to a recipient.

34. The method for sending a message of claim 33 wherein the source message is received as part of an XML template.

35. The method for sending a message of claim 33 wherein the encryption key is derived from the password.

36. The method for sending a message of claim 35 wherein the password is hashed to generate the encryption key.

37. The method for sending a message of claim 33 wherein the password is received as part of an XML template.

38. A method for sending and receiving a message, the method comprising the steps of:
preparing an encrypted message by encrypting a source message using an encryption key associated with a recipient and an encryption algorithm;
preparing a secure document comprising an HTML-compliant wrapper, the encrypted message, a processing script, and a decryption element;
forwarding the secure document to a recipient's device;
processing the wrapper of the secure document using a browser running on the recipient's device;
entering a password into the browser;
running the processing script of the secure document to access the decryption element;
recovering the source message by decrypting the encrypted message with the password and the decryption element; and
presenting the recovered source message to the recipient,
wherein the secure document allows the encrypted message to be decrypted and viewed on a device having a browser installed thereon, without a need for decryption software installed on the device.

39. The method for sending a message of claim 38 wherein the source message is received as part of an XML template.

40. The method for sending a message of claim 38 wherein the encryption key is derived from the password.

41. The method for sending a message of claim 40 wherein the password is hashed to generate the encryption key.

42. The method for sending a message of claim 38 wherein the password is received as part of an XML template.

43. A computer readable medium having stored therein a software module, which when executed performs the steps of:
preparing an encrypted message by encrypting a source message using an encryption key and an encryption algorithm;
preparing a secure document comprising an HTML-compliant wrapper, the encrypted message, a processing script, and a decryption element, wherein the processing script contains instructions for accessing the encrypted message, and wherein the decryption element includes a module capable of recovering the source message from the encrypted message when presented with a password by the recipient;
forwarding the secure document to a mail gateway module.
